(19) United States
(12) Patent Application Publication
(10) Pub. No.: US 2026/0142596 A1
(43) Pub. Date: May 21, 2026

(54) MOTOR CONTROL DEVICE

(71) Applicant: KABUSHIKI KAISHA TOYOTA JIDOSHOKKI, Aichi-ken (JP)

(72) Inventor: Masashi KUBOTA, Kariya-shi (JP)

(73) Assignee: KABUSHIKI KAISHA TOYOTA JIDOSHOKKI, Aichi-ken (JP)

(21) Appl. No.: 19/343,630

(22) Filed: Sep. 29, 2025

(30) Foreign Application Priority Data
Oct. 1, 2024 (JP) 2024-172642

(51) Int. Cl. H02P 21/22; H02P 21/00

(52) U.S. Cl. CPC H02P 21/22; H02P 21/0089

(57) ABSTRACT

A motor control device includes: a field-weakening control unit that performs field-weakening control based on a motor voltage command value; and a current command limit unit that limits each of a d-axis current command and a q-axis current command based on a current limit value. The field-weakening control unit increases a magnitude of the d-axis current command such that the motor voltage command value follows an output voltage maximum value when the motor voltage command value is equal to or larger than the output voltage maximum value. The current command limit unit sets the current limit value at a maximum torque current value corresponding to a rotation speed of a motor.

### CROSS REFERENCE TO RELATED APPLICATIONS

This nonprovisional application is based on Japanese Patent Application No. 2024-172642 filed on Oct. 1, 2024 with the Japan Patent Office, the entire contents of which are hereby incorporated by reference.

### BACKGROUND

### Field

The present disclosure relates to a motor control device.

### Description of the Background Art

For example, Japanese Patent Laying-Open No. 2006-141095 discloses a device that controls driving of a permanent magnet-type synchronous motor while performing field-weaking control. The field-weaking control is required when a motor voltage exceeds an allowable power supply voltage due to an increase in number of rotations (rotation speed) of a motor. Specifically, field-weaking control is performed by addition of a negative field-weaking current value to a d-axis current command value.

Japanese Patent Laying-Open No. 2014-128170 discloses a voltage limit ellipse indicating an output range of a current vector (a vector of a d-axis current and a q-axis current) that allows for operation under constraints of a rotation speed of a motor and a voltage (the above-mentioned allowable power supply voltage) that can be output from an inverter circuit. The motor can be operated when an end of the current vector is within (and also on) the voltage limit ellipse.

### SUMMARY

When the field-weakening control is performed, it is conceivable to change the magnitude of the d-axis current such that the end of the current vector is located on (follows) the voltage limit ellipse. In this case, the field-weakening control may be further performed beyond the d-axis current value at which the maximum torque corresponding to the rotation speed of the motor is generated. In this case, the torque of the motor lowers below the above-mentioned maximum torque and the motor current also increases, so that the motor efficiency decreases.

An object of the present technique is to provide a motor control device capable of suppressing a decrease in motor efficiency while performing field-weakening control.

A motor control device according to one aspect of the present disclosure is a motor control device that controls driving of a motor by using electric power supplied from a power supply. The motor control device includes: a voltage command unit that calculates a motor voltage command value that is a command value of a voltage output to the motor; a field-weakening control unit that performs field-weakening control based on the motor voltage command value; and a motor current limit unit that limits each of a command value of a d-axis current flowing through the motor and a command value of a q-axis current flowing through the motor based on a motor current limit value that is a limit value of a current flowing through the motor. An output voltage maximum value denotes a value of a maximum voltage that is able to be output from an inverter to the motor based on a voltage of the power supply. A maximum torque current value denotes a value of a current flowing through the motor when a torque of the motor reaches a maximum, the torque of the motor being a torque corresponding to a rotation speed of the motor. The field-weakening control unit performs the field-weakening control to decrease the motor voltage command value by increasing a magnitude of the command value of the d-axis current such that the motor voltage command value follows the output voltage maximum value, when the motor voltage command value is equal to or larger than the output voltage maximum value. The motor current limit unit sets the motor current limit value at a value that is based on the maximum torque current value.

In the motor control device according to one aspect of the present disclosure, the motor current limit value is set at a value that is based on the maximum torque current value as described above. Thereby, the magnitude of the command value of the d-axis current can be suppressed from increasing, by the field-weakening control, above the magnitude of the d-axis current value corresponding to the maximum torque current value. As a result, the torque of the motor can be suppressed from lowering below the maximum torque, and an excessive increase in the d-axis current can also be suppressed. Thereby, a decrease in motor efficiency can be suppressed.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a block diagram showing a configuration of a motor system according to one embodiment.

FIG. 2 is a diagram showing a detailed configuration of the motor system according to one embodiment.

FIG. 3 is a diagram showing a d-axis and a q-axis.

FIG. 4 is a diagram showing a detailed configuration of a controller according to one embodiment.

FIG. 5 is a flowchart illustrating field-weakening control.

FIG. 6 is a first diagram showing a constant induced voltage ellipse and a current limit circle according to one embodiment.

FIG. 7 is a second diagram showing the constant induced voltage ellipse and the current limit circle according to one embodiment.

FIG. 8 is a diagram showing a graph obtained by plotting map information.

FIG. 9 is a flowchart illustrating a process by a current command limit unit according to one embodiment.

FIG. 10 is a diagram showing a constant induced voltage ellipse and a current limit circle according to a modification of one embodiment.

FIG. 11 is a flowchart illustrating a process by a current command limit unit according to a modification of one embodiment.

### DESCRIPTION OF THE PREFERRED EMBODIMENTS

Embodiments of the present disclosure will be described in detail with reference to the accompanying drawings, in which the same or corresponding portions are denoted by the same reference characters, and the description thereof will not be repeated.

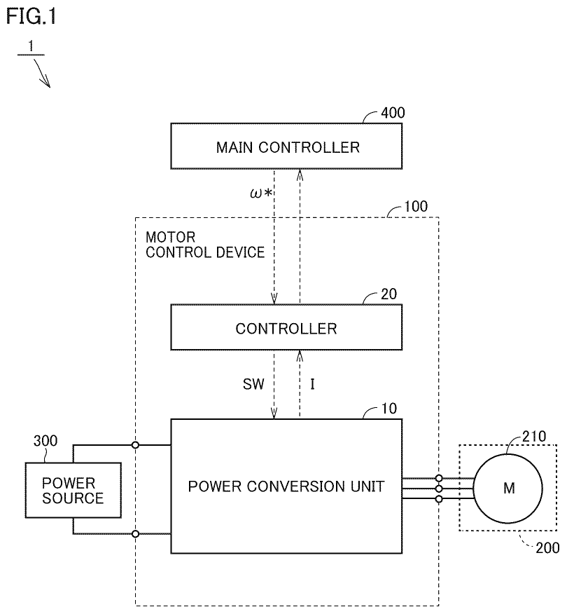

FIG. 1 is a diagram showing an overall configuration of a motor system 1 including a motor control device 100 according to the present embodiment. The motor system 1 is mounted, for example, in an electrically powered vehicle. Note that the use of the motor system 1 is not limited to an application for vehicles. The motor system 1 may be used in a stationary system (e.g., an air conditioning system). Further, in the present embodiment, the motor control device is configured to drive an electrically powered compressor, but the target controlled by the motor control device is not limited thereto. For example, the motor control device may be used to control a travel motor. The motor system 1 includes a motor control device 100, a motor 210 of an electrically powered compressor 200, a power source 300, and a main controller 400. The power source 300 is an example of the “power supply” in the present disclosure.

The power source 300 supplies electric power to the motor control device 100. The power source 300 is, for example, a direct-current (DC) power supply (a DC system) such as a vehicle-mounted storage battery or solar cell. When the motor system 1 is used in a stationary system, the power source 300 may be an alternating-current (AC) power supply (an AC system). In the case of an AC power supply, a rectifier for converting an alternating current into a direct current needs to be provided.

The motor control device 100 controls driving of the motor 210 by using electric power supplied from the power source 300. The motor control device 100 includes a power conversion unit 10 and a controller 20. The power conversion unit 10 performs a power conversion operation on the electric power supplied from the power source 300. The controller 20 controls the power conversion unit 10 in accordance with a control command from the main controller 400. The control command from the main controller 400 to the controller 20 includes a speed command (a command related to angular acceleration of the motor 210) ω*.

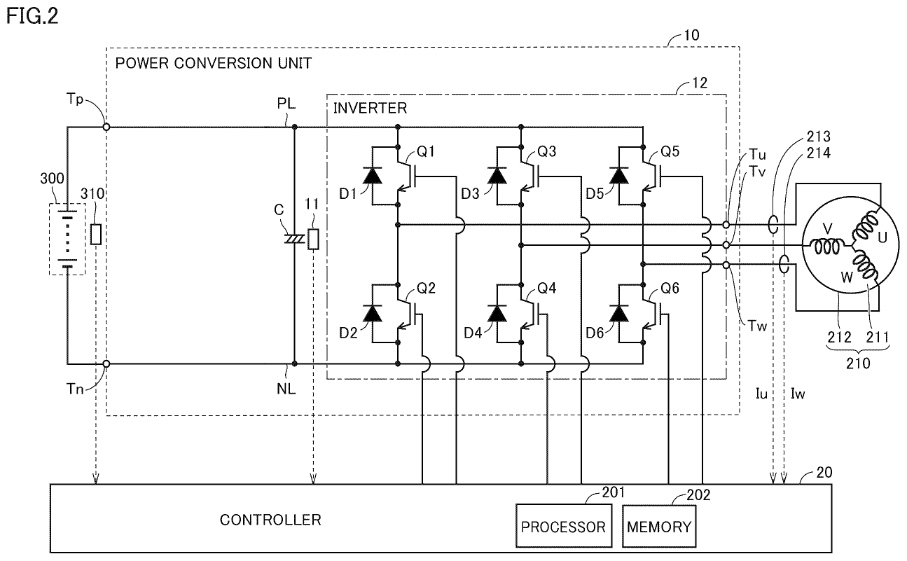

The motor 210 is a three-phase AC rotating electrical machine or a three-phase brushless DC rotating electrical machine and is, for example, an interior permanent magnet (IPM) motor. The motor 210 is not provided with a position sensor (a resolver) that detects the position of a rotor 211 (described later with reference to FIG. 2). Thus, the motor control device 100 performs sensorless control for the motor 210.

FIG. 2 is a diagram showing an example of the configuration of the motor system 1. Note that FIG. 2 does not show the main controller 400 (FIG. 1).

The power source 300 is a storage battery in the present example. The power source 300 outputs DC power to the power conversion unit 10 through DC terminals Tp and Tn of the power conversion unit 10. The power source 300 is provided with a monitoring unit (including a voltage sensor, a current sensor, and the like) 310 for monitoring the state of the power source 300. The monitoring unit 310 outputs the monitored voltage, current, and the like to the controller 20.

In accordance with a control command from the controller 20, the power conversion unit 10 converts DC power (a DC voltage) from the power source 300 into AC power (an AC voltage) and outputs the converted AC power (the AC voltage) to the motor 210. More specifically, the power conversion unit 10 includes, for example, a voltage sensor 11 and an inverter 12.

The voltage sensor 11 detects a voltage between power lines PL and NL, and outputs the detected voltage to the controller 20.

The inverter 12 is, for example, a two-level three-phase full-bridge circuit. In accordance with a control command from the controller 20, the inverter 12 converts DC power between power lines PL and NL into AC power, and outputs the converted AC power (the AC voltage) to AC terminals Tu, Tv, and Tw. In the present example, the inverter 12 includes six switching elements Q1 to Q6 and six freewheeling diodes D1 to D6. Each of the switching elements Q1 to Q6 is a metal-oxide-semiconductor field-effect transistor (MOSFET), an insulated gate bipolar transistor (IGBT), a bipolar transistor, and the like. Each of the freewheeling diodes D1 to D6 is connected in anti-parallel to a corresponding one of the switching elements Q1 to Q6. The switching elements Q1 and Q2 are connected in series to each other to form a U-phase arm of a full-bridge circuit. The switching elements Q3 and Q4 are connected in series to each other to form a V-phase arm of a full-bridge circuit. The switching elements Q5 and Q6 are connected in series to each other to form a W-phase arm of a full-bridge circuit. The U-phase arm, the V-phase arm, and the W-phase arm are connected to the AC terminals Tu, Tv, and Tw, respectively. Each phase arm is connected between the power lines PL and NL. When a MOSFET is used as each of the switching elements Q1 to Q6, a parasitic diode of the MOSFET substitutes as each of the freewheeling diodes D1 to D6.

The motor 210 includes a rotor 211 having permanent magnets and a stator 212 around which coils are wound. In the present example, the stator 212 has a U-phase coil, a V-phase coil, and a W-phase coil. Each phase coil has one end that is star-connected to a neutral point. Each phase coil has the other end that is connected to a point of connection between the switching elements in each phase arm of the inverter 12.

The motor 210 is provided with current sensors 213 and 214. The current sensor 213 detects a U-phase current Iu flowing through the motor 210. The current sensor 214 detects a W-phase current Iw flowing through the motor 210. Each of the current sensors 213 and 214 outputs the detected current to the controller 20. Note that the U-phase current Iu and a V-phase current Iv, or the V-phase current Iv and the W-phase current Iw may be output to the controller 20.

The controller 20 controls the inverter 12 based on the speed command ω* from the main controller 400 (FIG. 1) and the results detected by various sensors (the monitoring unit 310, the voltage sensor 11, the current sensors 213, 214, and the like). For example, the controller 20 outputs a switching signal SW to each of the six switching elements Q1 to Q6 included in the inverter 12. The switching signal SW (FIG. 1) is a pulse width modulation (PWM) signal.

The controller 20 includes a processor 201 and a memory 202 as main components. The processor 201 includes processing circuitry such as a central processing unit (CPU) or a micro processing unit (MPU). The memory 202 includes: a volatile storage device such as a dynamic random access memory (DRAM) and a static random access memory (SRAM); and a nonvolatile storage device such as a hard disk drive (HDD), a solid state drive (SSD), and a flash memory. The memory 202 stores a system program including an operating system (OS), a control program including a computer-readable code, and various parameters for the power conversion unit 10 to control the power conversion operation. The processor 201 reads a system program, a control program, and parameters, and deploys them onto the memory 202 for execution to thereby implement various computing processes. The computing process by the controller 20 may be implemented by an application specific integrated circuit (ASIC), a field programmable gate array (FPGA), and the like. The memory 202 is an example of the “storage unit” in the present disclosure.

It is not essential that the controller 20 and the main controller 400 are separately provided. The controller 20 may be configured to calculate the speed command ω* by itself.

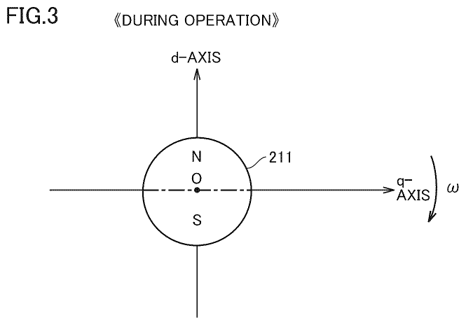

FIG. 3 is a diagram for illustrating the relation between the axes of coordinates and a magnetic pole position of the rotor 211 during the operation of the motor 210. As shown in FIG. 3, a d-axis extends from a rotation axis O of the rotor 211 toward an N pole of the rotor 211. The d-axis rotates at a rotation speed (an angular velocity) ω of the rotor 211. A q-axis extends orthogonal to the d-axis (extends in a direction in which the electrical angle advances by 90 degrees from the d-axis).

A d-axis current and a q-axis current in a d-q rotating coordinate system are denoted as Id and Iq, respectively. A d-axis current command and a q-axis current command are denoted as Id* and Iq*, respectively. The d-axis current Id is a current used to generate a magnetic field in the motor 210. The q-axis current Iq is a current corresponding to a torque of the motor 210.

Further, a d-axis inductance and a q-axis inductance of the coil in the stator 212 are denoted as Ld and Lq, respectively.

### <Functional Blocks>

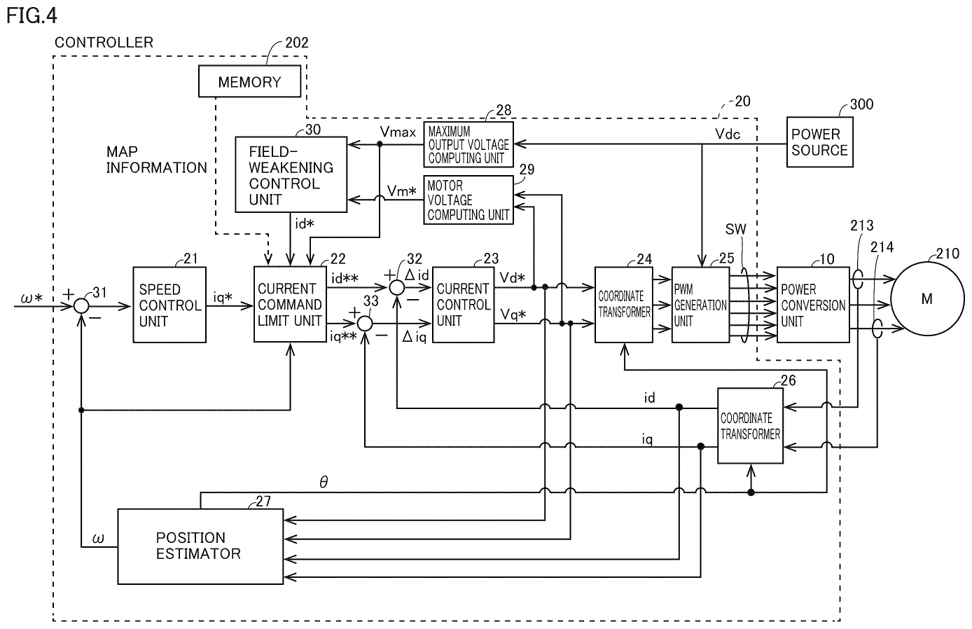

FIG. 4 is a functional block diagram of the controller 20 in the present embodiment. The controller 20 includes a speed control unit 21, a current command limit unit 22, a current control unit 23, a coordinate transformer 24, a PWM generation unit 25, a coordinate transformer 26, a position estimator 27, a maximum output voltage computing unit 28, a motor voltage computing unit 29, and a field-weakening control unit 30. Further, the controller 20 includes subtractors 31 to 33. Note that the current command limit unit 22 and the motor voltage computing unit 29 are examples of the “motor current limit unit” and the “voltage command unit”, respectively, in the present disclosure.

The subtractor 31 calculates an angular velocity error, for example, by subtracting the rotation speed ω (an estimated value) at the present time, which is output from the position estimator 27, from the speed command ω* input from the main controller 400 (FIG. 1) to the motor control device 100.

The speed control unit 21 generates a torque command value such that the angular velocity error input from the subtractor 31 approaches 0 (zero) and, according to the PI control, generates the q-axis current command Iq* for causing the generated torque command value. The speed control unit 21 outputs the q-axis current command Iq* to the current command limit unit 22.

The field-weakening control unit 30 outputs the d-axis current command Id* to the current command limit unit 22. A specific process by the field-weakening control unit 30 will be described later.

The current command limit unit 22 outputs, to the subtractor 32, a d-axis current command Id** obtained by limiting the received d-axis current command Id*. The current command limit unit 22 outputs, to the subtractor 33, a q-axis current command Iq** obtained by limiting the received q-axis current command Iq*.

Based on a current limit value Imlim that is a limit value of the current flowing through the motor 210, the current command limit unit 22 limits each of the d-axis current command Id* and the q-axis current command Iq* each flowing through the motor 210. A specific process by the current command limit unit 22 will be described later. Note that the current limit value Imlim is an example of the “motor current limit value” in the present disclosure.

The subtractor 32 calculates a d-axis current deviation ΔId that is a deviation between the d-axis current Id from the coordinate transformer 26 and the d-axis current command Id** from the current command limit unit 22 (ΔId=Id**−Id), and then, outputs the d-axis current deviation ΔId to the current control unit 23.

The subtractor 33 calculates a q-axis current deviation ΔIq that is a deviation between the q-axis current Iq from the coordinate transformer 26 and the q-axis current command Iq** from the current command limit unit 22 (ΔIq=Iq**−Iq), and then, outputs the q-axis current deviation ΔIq to the current control unit 23.

The current control unit 23 performs proportional-integral (PI) calculation of the d-axis current deviation ΔId from the subtractor 32 to calculate a d-axis voltage command Vd*. The current control unit 23 outputs the calculated d-axis voltage command Vd* to the coordinate transformer 24 and the motor voltage computing unit 29. The current control unit 23 performs proportional-integral (PI) calculation of the q-axis current deviation ΔIq from the subtractor 33 to calculate a q-axis voltage command Vq*. The current control unit 23 outputs the calculated q-axis voltage command Vq* to the coordinate transformer 24 and the motor voltage computing unit 29.

According to a known coordinate transformation formula (dq two phases→UVW three-phase conversion formula) using an estimated angle (position) θ of the rotor 211 that is input from the position estimator 27, the coordinate transformer 24 transforms the d-axis voltage command Vd* and the q-axis voltage command Vq* on dq two-phase coordinates into a U-phase voltage command, a V-phase voltage command, and a W-phase voltage command on UVW three-phase coordinates. The coordinate transformer 24 outputs each of the U-phase voltage command, the V-phase voltage command, and the W-phase voltage command to the PWM generation unit 25.

The PWM generation unit 25 further generates the switching signal SW from the voltage commands in the above-mentioned three phases. More specifically, the PWM generation unit 25 generates a PWM signal as the switching signal SW based on the comparison between the voltage command of each phase and the predefined carrier wave. The PWM generation unit 25 outputs the generated switching signal SW to the power conversion unit 10 (the inverter 12 in FIG. 2).

The coordinate transformer 26 calculates the d-axis current Id and the q-axis current Iq based on the U-phase current Iu detected by the current sensor 213 and the W-phase current Iw detected by the current sensor 214. The coordinate transformer 26 calculates the d-axis current Id and the q-axis current Iq according to a known coordinate transformation formula (UVW three phases→dq two-phase conversion formula) using the estimated angle θ of the rotor 211 input from the position estimator 27. The coordinate transformer 26 outputs the d-axis current Id to the subtractor 32, and outputs the q-axis current Iq to the subtractor 33.

The position estimator 27 calculates the estimated angle θ of the rotor 211 and the rotation speed ω of the rotor 211 based on: the d-axis current Id and the q-axis current Iq output from the coordinate transformer 26; and the d-axis voltage command Vd* and the q-axis voltage command Vq* output from the current control unit 23. Specifically, the position estimator 27 calculates (estimates) the rotation speed ω and the estimated angle θ at which the position error (an error of θ) estimated by the PI control converges to 0 (zero).

Based on a power supply voltage Vdc of the power source 300, the maximum output voltage computing unit 28 calculates an output voltage maximum value Vmax that can be output from the inverter 12 to the motor 210 (that can be applied to the motor 210). Specifically, the maximum output voltage computing unit 28 multiplies the power supply voltage Vdc by the maximum modulation factor of the PWM generation unit 25 to thereby calculate the output voltage maximum value Vmax (Vmax=Vdc×maximum modulation factor).

The motor voltage computing unit 29 calculates a motor voltage command value Vm* that is a command value of the voltage applied to (induced in) the motor 210. The motor voltage command value Vm* is calculated using the d-axis voltage command Vd* and the q-axis voltage command Vq* that are output from the current control unit 23. Specifically, the motor voltage command value Vm* is obtained by the following equation (1).

$$V {m}^{*} = √ ( {Vd}^{* 2} + V {q}^{* 2} ) \qquad ( 1 )$$

In the present embodiment, the motor voltage computing unit 29 calculates the motor voltage command value Vm* by using the d-axis voltage command Vd* and the q-axis voltage command Vq*, but may calculate the motor voltage command value Vm*, for example, by directly detecting the voltages Vu, Vv, and Vw applied to the motor 210.

The field-weakening control unit 30 performs field-weakening control based on the output voltage maximum value Vmax output from the maximum output voltage computing unit 28 and the motor voltage command value Vm* output from the motor voltage computing unit 29.

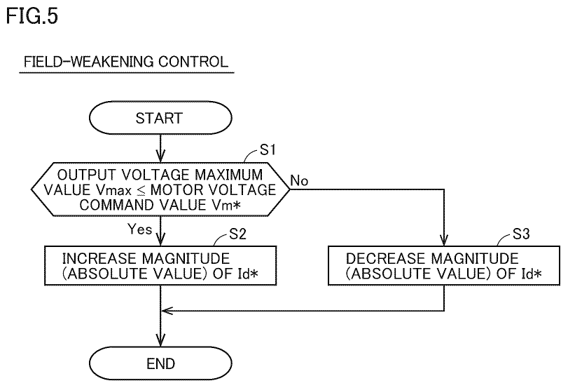

FIG. 5 is a flowchart illustrating a process in the field-weakening control unit 30. In step S1, the field-weakening control unit 30 determines whether or not the output voltage maximum value Vmax is equal to or smaller than the motor voltage command value Vm* (Vmax≤Vm*). When the output voltage maximum value Vmax is equal to or smaller than the motor voltage command value Vm* (Yes in S1), the process proceeds to step S2. When the output voltage maximum value Vmax is larger than the motor voltage command value Vm* (No in S1), the process proceeds to step S3.

In step S2, the field-weakening control unit 30 increases the magnitude (an absolute value) of the d-axis current command Id*. Since the d-axis current command Id* is a negative value, the d-axis current command Id* is decreased in the field-weakening control.

In step S3, the field-weakening control unit 30 decreases the magnitude (an absolute value) of the d-axis current command Id*. In other words, the d-axis current command Id* is increased in the field-weakening control. Note that an upper limit value of the d-axis current command Id* is 0 (zero). Hereinafter, increasing the magnitude (the absolute value) of the d-axis current command Id* is described as decreasing the d-axis current command Id*, and decreasing the magnitude of the d-axis current command Id* is described as increasing the d-axis current command Id*.

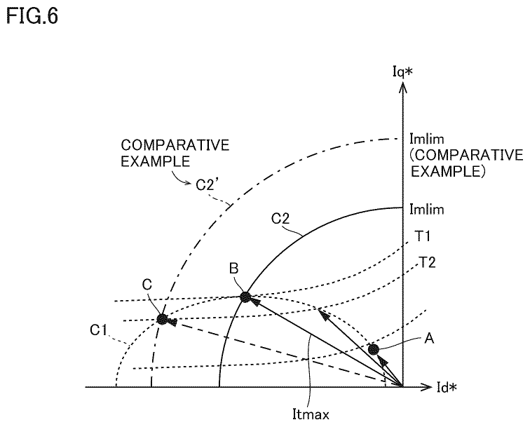

FIG. 6 is a diagram showing the d-axis current command Id* and the q-axis current command Iq* applied during the field-weakening control. FIG. 6 shows a constant induced voltage ellipse C1 under a prescribed condition. The constant induced voltage ellipse C1 satisfies the following equation (2). In the following equation (2), ψa shows a value that is √3 times as large as the effective value of the armature magnetic flux linkage caused by a permanent magnet. Further, Vom denotes an output voltage maximum value (output voltage maximum value Vmax).

$${( L d \times id + ψ a )}^{2} + {( L q \times i q )}^{2} = {( Vom / ω )}^{2} \qquad ( 2 )$$

In a region within the constant induced voltage ellipse C1, the motor voltage command value Vm* is equal to or smaller than the output voltage maximum value Vmax (Vm*≤Vmax). In other words, the output voltage maximum value Vmax and the motor voltage command value Vm* are equal to each other on the outer peripheral edge of the constant induced voltage ellipse C1 (Vmax=Vm*).

When the motor voltage command value Vm* becomes equal to or larger than the output voltage maximum value Vmax (i.e., reaches Vmax), the field-weakening control unit 30 performs field-weakening control to decrease the motor voltage command value Vm* by decreasing the d-axis current command Id* such that the motor voltage command value Vm* follows the output voltage maximum value Vmax.

For example, when the torque required at a point A on the constant induced voltage ellipse C1 rises, the q-axis current command Iq* is increased. In this case, the current vector (the tip of the arrow) extends to the outside of the constant induced voltage ellipse C1. The field-weakening control unit 30 decreases the d-axis current command Id* in order to return the current vector to the inside of the constant induced voltage ellipse C1 (on the outer peripheral edge of C1).

FIG. 6 shows a current limit circle C2 indicating the current limit value Imlim that is a limit value of the current flowing through the motor 210. The motor 210 is drivable only when the current vector is within the current limit circle C2. In other words, the process of decreasing the d-axis current command Id* by the field-weakening control can be performed until the current vector reaches the outer peripheral edge of the current limit circle C2.

FIG. 6 shows a current limit circle C2′ as a comparative example. When the current limit value Imlim indicates a radius of the current limit circle C2, the field-weakening control can be performed until the current vector reaches a point B. When the current limit value Imlim indicates a radius of the current limit circle C2′, the field-weakening control can be performed until the current vector reaches a point C.

In this case, the point B in FIG. 6 indicates a value of a current (a maximum torque current value Itmax) flowing through the motor 210 when the torque of the motor 210 corresponding to the rotation speed of the motor 210 reaches a maximum. In other words, at the point B, a torque curve T1 indicating the maximum torque corresponding to the rotation speed of the motor 210 is in contact with the constant induced voltage ellipse C1.

On the other hand, at the point C, a torque curve T2 smaller in torque than the torque curve T1 intersects with the constant induced voltage ellipse C1. In other words, the torque of the motor 210 decreases since the field-weakening control is performed until reaching the point C beyond the point B.

Thus, in the present embodiment, the current command limit unit 22 sets the current limit value Imlim at the maximum torque current value Itmax. Thereby, the radius of the current limit circle C2 becomes equal to the maximum torque current value Itmax.

As a result, the process of decreasing the d-axis current command Id* by the field-weakening control is stopped at the point B. Thereby, the d-axis current command Id* can be suppressed from decreasing beyond the point B. As a result, a decrease in torque of the motor 210 can be suppressed. Further, an excessive flow of the current into the motor 210 (an increase in current vector) can be suppressed. As a result, deterioration in efficiency of the motor 210 can be suppressed.

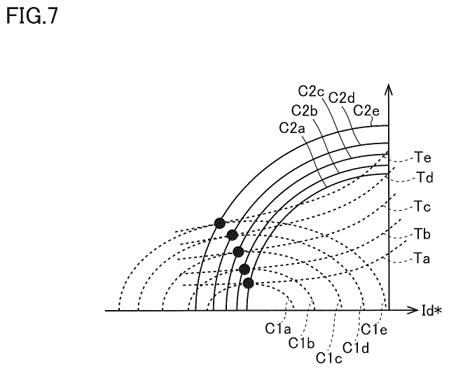

FIG. 7 shows constant induced voltage ellipses C1a, C1b, C1c, C1d, and C1e that are different in rotation speed ω of the motor 210. The rotation speed ω of the motor 210 is higher in the order of the constant induced voltage ellipses C1a, C1b, C1c, C1d, and C1e. In other words, as the rotation speed ω of the motor 210 is higher, the constant induced voltage ellipse is smaller. FIG. 7 shows torque curves Ta, Tb, Tc, Td, and Te corresponding to the constant induced voltage ellipses C1a, C1b, C1c, C1d, and C1e, respectively (reaching the maximum torque).

FIG. 7 shows current limit circles C2a, C2b, C2c, C2d, and C2e. The radii of the current limit circles C2a, C2b, C2c, C2d, and C2e indicate maximum torque current values Itmax corresponding to the constant induced voltage ellipses C1a, C1b, C1c, C1d, and C1e, respectively. In other words, the maximum torque current value Itmax changes according to the rotation speed ω of the motor 210. Although not shown in FIG. 7, as the output voltage maximum value Vmax is smaller, the constant induced voltage ellipse is smaller, and thus, the maximum torque current value Itmax changes also according to the output voltage maximum value Vmax.

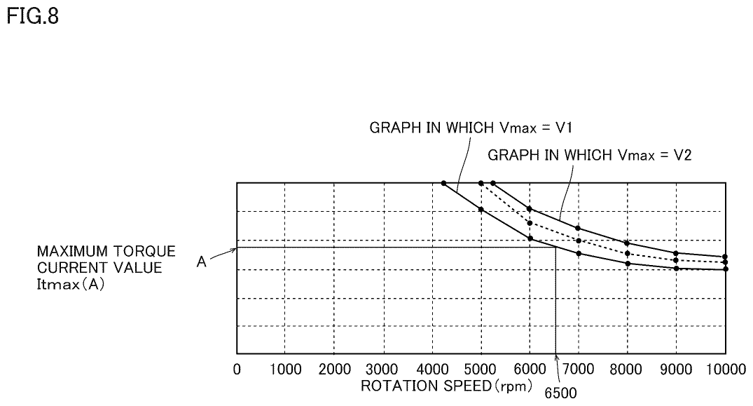

FIG. 8 is a graphic plot of a map stored in the memory 202 (FIG. 2). In the map, the rotation speed ω and the output voltage maximum value Vmax are associated with the maximum torque current value Itmax. FIG. 8 shows a graph indicating the relation between the rotation speed ω (the horizontal axis) and the maximum torque current value Itmax (the vertical axis), the relation being associated with each of the output voltage maximum values Vmax (voltages V1 and V2 in FIG. 8) different from each other.

The current command limit unit 22 sets the current limit value Imlim based on the rotation speed ω at the present time that is output from the position estimator 27 (FIG. 4), the output voltage maximum value Vmax output from the maximum output voltage computing unit 28, and the map information acquired from the memory 202. Specifically, the current command limit unit 22 determines the maximum torque current value Itmax corresponding to the rotation speed ω and the output voltage maximum value Vmax based on the above-mentioned map, and sets the current limit value Imlim at the value of the determined maximum torque current value Itmax.

When at least one of the rotation speed ω and the output voltage maximum value Vmax does not exist in the map, the current command limit unit 22 may perform linear interpolation based on the information of the map to calculate the maximum torque current value Itmax.

For example, it is assumed that the output voltage maximum value Vmax is V1 and the rotation speed ω at the present time is 6500 rpm. In this case, as shown in FIG. 8, the current command limit unit 22 may perform linear interpolation that is based on the information of the map, to thereby calculate the maximum torque current value Itmax (A in FIG. 8) corresponding to 6500 rpm.

Further, the current command limit unit 22 may perform linear interpolation that is based on a graph in which the output voltage maximum value Vmax is V1 and a graph in which the output voltage maximum value Vmax is V2, to thereby calculate the relation (a dashed-line graph in FIG. 8) between Itmax and ω at Vmax having a value between the voltages V1 and V2 (for example, Vmax=(V1+V2)/2).

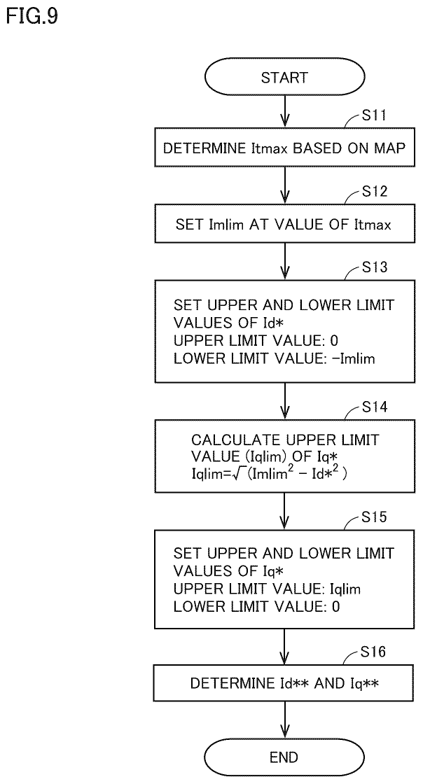

FIG. 9 is a flowchart illustrating a process by the current command limit unit 22.

In step S11, the current command limit unit 22 determines the maximum torque current value Itmax based on the information of the map, the rotation speed ω, and the output voltage maximum value Vmax.

In step S12, the current command limit unit 22 sets the current limit value Imlim at the value of the maximum torque current value Itmax determined in step S11. In other words, the current command limit unit 22 sets the current limit value Imlim based on the rotation speed ω at the present time and the information stored in the memory 202. With such a configuration, the information about the current limit value Imlim can be easily acquired based on the map, as compared with the case where the current limit value Imlim is calculated by computation in each time based on the rotation speed ω of the motor 210 at the present time. Thereby, the processing load on the motor control device 100 can be reduced. Further, the maximum torque current value Itmax changes also based on the output voltage maximum value Vmax in addition to the rotation speed ω of the motor 210. Thus, by using the map in which the rotation speed ω of the motor 210 and the output voltage maximum value Vmax are associated with the maximum torque current value Itmax, the process of limiting the current by the current command limit unit 22 can be more appropriately performed.

In step S13, the current command limit unit 22 sets an upper limit value and a lower limit value of the d-axis current command Id*. Specifically, the current command limit unit 22 sets the upper limit value of the d-axis current command Id* at 0 (zero). The current command limit unit 22 sets the lower limit value of the d-axis current command Id* at −Imlim. In other words, the current command limit unit 22 sets the upper limit value of the magnitude of the d-axis current command Id* at the maximum torque current value Itmax. This makes it possible to suppress an excessive increase in the d-axis current Id that causes a decrease in the maximum torque. As a result, the torque of the motor 210 can be easily suppressed from decreasing below the maximum torque.

In step S14, the current command limit unit 22 calculates Iqlim that is an upper limit value of the q-axis current command Iq*. Iqlim is calculated by the following equation (3).

$$Iq lim = √ ( I m {lim}^{2} - I {d}^{* 2} ) \qquad ( 3 )$$

In step S15, the current command limit unit 22 sets an upper limit value and a lower limit value of the q-axis current command Iq*. Specifically, the current command limit unit 22 sets the upper limit value of the q-axis current command Iq* at Iqlim. The current command limit unit 22 sets the lower limit value of the q-axis current command Iq* at 0 (zero). In other words, the current command limit unit 22 may set the upper limit value of the magnitude of the q-axis current command Iq* at a square root value of the difference value obtained by subtracting the square value of the d-axis current command Id* from the square value of the maximum torque current value Itmax. Thereby, the magnitude of the q-axis current command Iq* can be suppressed from exceeding the maximum torque current value Itmax.

In step S16, the current command limit unit 22 determines the d-axis current command Id** and the q-axis current command Iq** based on the upper and lower limit values in each of steps S13 and S15.

### <Modifications>

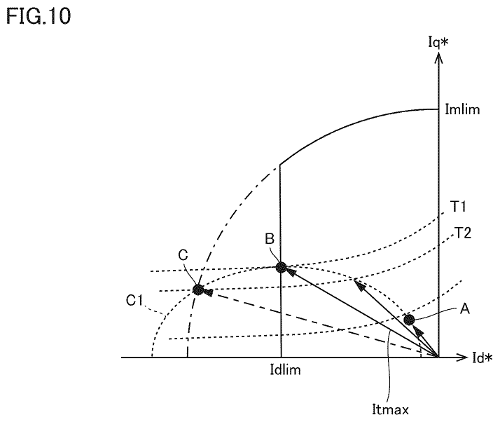

FIG. 10 is a diagram showing the d-axis current command Id* and the q-axis current command Iq* in a modification of the above-described embodiment. In the present modification, the current limit value Imlim is constant. On the other hand, the upper limit value of the magnitude of the d-axis current command Id* is Idlim. Idlim is a d-axis component of the maximum torque current value Itmax. Although not shown, in the present modification, the memory 202 (FIG. 2) stores a map in which the rotation speed ω and the output voltage maximum value Vmax are associated with Idlim. Note that Idlim is an example of the “motor current limit value” in the present disclosure.

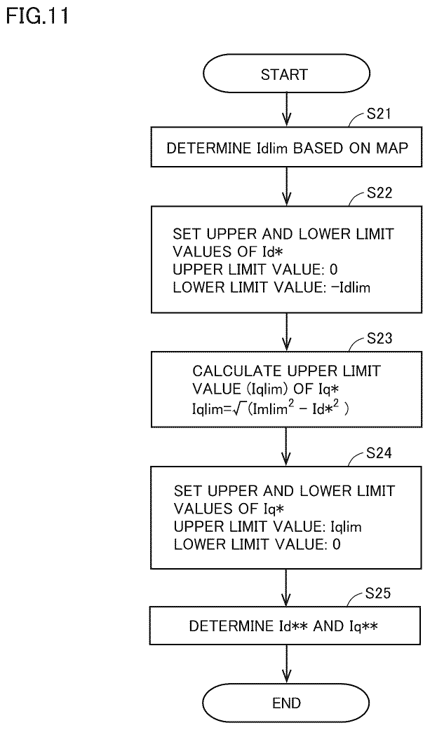

FIG. 11 is a flowchart illustrating a process by a current command limit unit corresponding to a modification in FIG. 10.

In step S21, Idlim that is a lower limit value of the d-axis current command Id* is determined based on the map information, the rotation speed ω, and the output voltage maximum value Vmax.

In step S22, the upper limit value of the d-axis current command Id* is set at 0 (zero), and the lower limit value of the d-axis current command Id* is set at −Idlim.

In step S23, Iqlim that is an upper limit value of the q-axis current command Iq* is calculated by the above-mentioned equation (3). Note that the current limit value Imlim is a fixed value set in advance.

In step S24, the upper limit value of the q-axis current command Iq* is set at Iqlim, and the lower limit value of the q-axis current command Iq* is set at 0 (zero).

In step S25, the d-axis current command Id** and the q-axis current command Iq** are determined based on the upper and lower limit values in each of steps S22 and S24.

In the example described in the above embodiment and modification, the process of limiting a current value based on the information of the map is performed, but the present disclosure is not limited thereto. Alternatively, Iqlim or Idlim may be calculated by computation based on the rotation speed ω and the output voltage maximum value Vmax without using the map.

Further, in the above-described embodiment and modification, the map based on the output voltage maximum value Vmax is used, but the map based on the power supply voltage Vdc may be used instead of the output voltage maximum value Vmax.

In the example of the map described in the above embodiment, the rotation speed ω and the output voltage maximum value Vmax are associated with the maximum torque current value Itmax, but the present disclosure is not limited thereto. For example, only one of the rotation speed ω and the output voltage maximum value Vmax may be associated with the maximum torque current value Itmax in the map.

Although the embodiments of the present disclosure have been described, it should be understood that the embodiments disclosed herein are illustrative and not restrictive in every respect. The scope of the present disclosure is defined by the terms of the claims, and is intended to include any modifications within the scope and meaning equivalent to the terms of the claims.

What is claimed is:

1. A motor control device that controls driving of a motor by using electric power supplied from a power supply, the motor control device comprising:
a voltage command unit that calculates a motor voltage command value that is a command value of a voltage output to the motor;
a field-weakening control unit that performs field-weakening control based on the motor voltage command value; and
a motor current limit unit that limits each of a command value of a d-axis current flowing through the motor and a command value of a q-axis current flowing through the motor based on a motor current limit value that is a limit value of a current flowing through the motor, wherein
an output voltage maximum value denotes a value of a maximum voltage that is able to be output from an inverter to the motor based on a voltage of the power supply,
a maximum torque current value denotes a value of a current flowing through the motor when a torque of the motor reaches a maximum, the torque of the motor being a torque corresponding to a rotation speed of the motor,
the field-weakening control unit performs the field-weakening control to decrease the motor voltage command value by increasing a magnitude of the command value of the d-axis current such that the motor voltage command value follows the output voltage maximum value, when the motor voltage command value is equal to or larger than the output voltage maximum value, and
the motor current limit unit sets the motor current limit value at a value that is based on the maximum torque current value.

2. The motor control device according to claim 1, wherein the motor current limit unit sets an upper limit value of the magnitude of the command value of the d-axis current at the maximum torque current value.

3. The motor control device according to claim 2, wherein the motor current limit unit sets an upper limit value of a magnitude of the command value of the q-axis current at a square root value of a difference value obtained by subtracting a square value of the command value of the d-axis current from a square value of the maximum torque current value.

4. The motor control device according to claim 1, further comprising a storage unit that stores a map in which the rotation speed and the output voltage maximum value are associated with a value that is based on the maximum torque current value, wherein
the motor current limit unit sets the motor current limit value based on the rotation speed at a present time and information stored in the storage unit.
